(19) United States
(12) Patent Application Publication
(10) Pub. No.: US 2024/0150213 A1
(43) Pub. Date: May 9, 2024

(54) Multiple Mold For Production Of At Least Two Glass-Ceramic Blanks For Dental Purposes, Use Of A Multiple Mold, Compression Apparatus And Continuous System

(71) Applicant: Ivoclar Vivadent AG, Schaan (LI)

(72) Inventors: Lars ARNOLD, Sevelen (CH); Walter ENTNER, Rankweil (AT)

(21) Appl. No.: 18/502,770

(22) Filed: Nov. 6, 2023

(30) Foreign Application Priority Data
Nov. 8, 2022 (EP) 22206188.9

(51) Int. Cl. C03B 11/06; C03B 11/12

(52) U.S. Cl. CPC C03B 11/06; C03B 11/122; C03B 11/125

(57) ABSTRACT

A multiple mold (42) for production of at least two glass-ceramic blanks. The glass-ceramic blanks are for dental purposes and are produced from at least two powder blanks by hot pressing. The multiple mold (42) includes a frame (48) that defines at least sections of a receiving volume (50) for the at least two powder blanks. Additionally provided is a separating element (52) which is disposed within the receiving volume (50) and divides the receiving volume (50) into at least two subvolumes, each of which is designed to accommodate one of the at least two powder blanks. Also described are the use of the multiple mold (42) for production of a glass-ceramic blank for dental purposes, a compression apparatus and a continuous system for production of glass-ceramic blanks for dental purposes.

### CROSS-REFERENCE TO RELATED APPLICATIONS

This application claims priority to European patent application No. 22206188.9 filed on Nov. 8, 2022, the disclosure of which is incorporated herein by reference in its entirety.

### TECHNICAL FIELD

The invention relates to a multiple mold for production of at least two glass-ceramic blanks for dental purposes from at least two powder blanks by hot pressing. Moreover, the invention is directed to use of a multiple mold for production of a glass-ceramic blank for dental purposes. The invention also relates to a compression apparatus having a reduced-pressure chamber. The invention is additionally directed to a continuous system for production of glass-ceramic blanks for dental purposes.

### BACKGROUND

In this connection, the use of glass-ceramic blanks in dental technology is known. These are of particularly good suitability for the production of esthetically demanding dental restorations having very good optical and mechanical properties.

U.S. Pat. No. 6,089,860, 20200115267, are directed to glass, glass-ceramic and ceramic production processes and are hereby incorporated by reference in their entirety.

### SUMMARY

It is an object of the invention to further improve the production of glass-ceramic blanks. In particular, a way of producing glass-ceramic blanks in an efficient manner is to be provided.

The object is achieved by a multiple mold for production of at least two glass-ceramic blanks for dental purposes. The glass-ceramic blanks are produced from at least two powder blanks by hot pressing. The multiple mold comprises a frame that defines at least sections of a receiving volume (50) for the at least two powder blanks. The multiple mold also comprises at least one separating element which is disposed within the receiving volume and divides the receiving volume into at least two subvolumes, each of which is designed to accommodate one of the at least two powder blanks. In this connection, a multiple mold is understood to mean a mold by means of which at least two glass-ceramic blanks can be produced simultaneously. The multiple mold is a mechanically coherent unit. For example, the multiple mold has a single die. Such a die is thus used for the production of the at least two glass-ceramic blanks. In a multiple mold, a relative position of the subvolumes is defined in a fixed manner. A powder blank is understood here to mean an amount of powder from which a glass-ceramic blank is produced. The amount of powder may take the form of a green body or white body. The amount of powder may also be a simple powder aggregate. The construction of the multiple mold composed of frame and separating element is structurally simple. This means that the multiple mold is long-lived and robust. It is thus possible with the multiple mold, in a reliable manner, to simultaneously produce at least two glass-ceramic blanks. This is efficient, especially by comparison with the use of a single mold.

In one working example, the frame is rectangular, especially square. It is also possible that the frame is round, for example circular. In all variants, the frame may be referred to as ring-shaped. Such a frame is mechanically stable.

In a case in which the frame is rectangular, the separating elements and the subvolumes may be cuboidal. It is thus possible to arrange separating elements and subvolumes in an efficient manner within the receiving volume defined by the frame. The receiving volume defined by the frame can thus be exploited efficiently by subvolumes. In a case in which the frame is circular, it is of course also possible for cuboidal separating elements and cuboidal subvolumes to be disposed within the interior thereof. For this purpose, however, it is necessary to use compensating elements, for example in the form of compensation plates, which make the round shape of the frame compatible with the cuboid shape of the subvolumes and separating elements.

A round frame may additionally act as tension ring.

The multiple mold may also comprise a support plate with a support surface to directly or indirectly bear the at least two powder blanks. Such a support plate may also be referred to as base plate. In this connection, directly bearing is understood to mean that the at least two powder blanks make contact with the support plate directly, i.e. without intervening elements. In the case of indirect bearing, there is accordingly at least one intervening element disposed between the support plate and the powder blanks, for example separating elements. It is always the case that a single support plate is used to jointly bear the at least two powder blanks. The structure of the multiple mold is thus still structurally simple. Therefore, the multiple mold is long-lived and robust. It is thus possible in a reliable manner to simultaneously produce at least two glass-ceramic blanks.

In one variant, the multiple mold comprises a heating apparatus for heating of at least a section of the receiving volume. It is thus possible to subject the powder blanks to heat treatment.

The heating apparatus may comprise at least two separate heating segments for independent heating of two different sections of the receiving volume. This configuration has the advantage that a temperature distribution can be established in a controlled manner within the multiple mold. In particular, it is possible in this way to achieve an equal distribution of temperature within the multiple mold that meets tight tolerance requirements.

In one working example, the heating apparatus comprises at least one induction heating element. By means of such a heating element, it is possible to reliably and precisely heat the receiving volume and any powder blanks positioned therein.

The induction heating element is designed, for example, as an inductive heating ring or inductive heating plate.

In another working example, the heating apparatus comprises at least one electrical resistance heating element. An electrical resistance heating element generates heat when an electrical current flows through it. It is also possible by means of such a heating element to precisely and reliably heat the receiving volume and any powder blanks positioned therein.

In one alternative design, the separating element is formed at least in sections as a resistance heating element. The separating element thus fulfills two functions. It firstly divides the receiving volume into subvolumes. It secondly serves to heat the receiving volume and any powder blanks present therein. It will be apparent that, for this purpose, the separating element must comprise an electrically conductive material. Such a configuration has the advantage that a heating effect can be provided within the receiving volume. In this way, it is possible to efficiently and reliably heat powder blanks disposed in the receiving volume.

In one variant, only a section of the separating element comprises an electrically conductive material. In this way, a current flow pathway through the separating element can be defined specifically. This allows the site of generation of heat to be fixed precisely.

In one variant in which the multiple mold comprises multiple separating elements, it is also possible for only some separating elements to comprise an electrically conductive material. Accordingly, other separating elements take the form of electrical insulators. In this way, a current flow pathway can be influenced in a specific manner and hence a site of generation of heat can be defined precisely.

The multiple mold may comprise at least two resistance heating elements, and the at least two resistance heating elements may have different electrical resistances. In this way, it is possible to easily and reliably set a locally generated amount of heat or heating output. This can be used firstly for the purpose of generating different temperature levels within the multiple mold. Secondly, it is thus possible to achieve an equal distribution of temperature with high precision.

In this connection, the different electrical resistances can be brought about by different material-specific resistances, meaning that the resistance heating elements are made from different material. Alternatively, the different resistances in the broadest sense may be brought about by different geometries of the resistance heating elements.

It is emphasized that, in the applications of the multiple mold that serve for production of glass-ceramic blanks for dental purposes, the powder blanks are not electrically conductive. The powder blanks are thus electrical insulators. There is thus no current flowing through the powder blanks, and they do not generate any heat.

In one variant, the separating element comprises a graphite material or has been produced from a graphite material. This has two advantages. Firstly, graphite material is electrically conductive, such that the separating element can achieve a heating effect. Furthermore, graphite material has good nonstick properties. This prevents a powder blank from sticking to the separating element in an unwanted manner.

A separating element comprising a graphite material may comprise a separating element body made of a metallic or ceramic material coated with the graphite material. If the separating element body is produced from a ceramic material, it may be electrically conductive or electrically insulating.

It is of course also possible that the separating element has been produced from graphite material as a whole.

In one working example, a clamp apparatus for clamping the separating element and the at least two powder blanks within the receiving volume is provided on the frame. In this way, the separating element and the at least two powder blanks are held in a defined position during the production of the glass-ceramic blanks. In one example, the clamp apparatus comprises mechanical clamp elements, for example screws, which can be moved relative to the frame in order to bring about clamping. It is also possible to form the clamp apparatus by exploiting the thermal expansion properties of the frame and the separating elements. In particular, in this context, the frame may have been manufactured from a material having only a comparatively low thermal expansion. In particular, the thermal expansion of the frame is much lower than the thermal expansion of the separating elements. If such a multiple mold is heated, the desired clamping takes place. In this context, the frame has been manufactured, for example, from a ceramic material. The frame may also have been manufactured from a carbon fiber-reinforced carbon. This is understood to mean a material having a carbon or graphite matrix that has been reinforced with carbon fibers.

The clamp apparatus may thus be formed at least in sections as a resistance heating element. Thus, at least one section of the clamp apparatus is electrically conductive. If the sections of the clamp apparatus in the form of a resistance heating element come into direct contact with the powder blank, they may be manufactured from graphite material, for example.

Within the receiving volume and adjoining at least one of the powder blanks and/or adjoining the separating element, a compensation plate may be provided. This compensation plate may serve for compensation of position and/or compensation of force. In the first alternative, the compensation plate thus has the effect that the subvolume for the powder blanks is precisely positioned. In the second alternative, the aim is to be able to introduce a controlled force, for example a tension force, into the powder blanks.

The compensation plate may thus be formed at least in sections as a resistance heating element. The compensation plate is thus utilized for the purpose of generating heat that serves for heat treatment of the powder blanks. For this purpose, the corresponding sections of the compensation plate must again be electrically conductive. For example, these sections may have been produced from a graphite material. If these come into contact with a powder blank, this is additionally advantageous because unwanted adhesion of the powder blank on the compensation plate is thus avoided.

In one embodiment, two or more separating elements and subvolumes are arranged alternately in a first direction that extends from a first end face of the frame to a second end face of the frame. The first end face and the second end face are opposite one another. Powder blanks and separating elements are thus arranged alternately in one dimension. In this way, it is possible in an efficient manner to produce two or more glass-ceramic blanks simultaneously.

It is also possible for two or more separating elements and subvolumes to be arranged alternately in a second direction at right angles to the first direction. The subvolumes and separating elements are thus arranged in a two-dimensional pattern. In this way, it is possible to produce a comparatively high number of glass-ceramic blanks simultaneously.

It is also possible for two or more separating elements and subvolumes to be arranged alternately in a third direction at right angles to the first direction and at right angles to the second direction. The separating elements and subvolumes are thus arranged in a pattern that extends three-dimensionally. The multiple mold is thus designed to produce a particularly large number of glass-ceramic blanks simultaneously.

In addition, the object is achieved by the use of a multiple mold, especially the multiple mold of the invention, for production of a glass-ceramic blank for dental purposes, especially for a dental restoration. In this connection, the glass-ceramic blank may also be referred to as a dental machining blank, dental CAD/CAM blank or dental restoration blank. Such a glass-ceramic blank is typically first processed by material removal to produce a dental restoration, for example by machining and/or grinding, and then subjected to a heat treatment. In the course of the heat treatment, the glass-ceramic blank is cured, which is the result of crystallization processes in particular. By means of the multiple mold, it is possible to produce glass-ceramic blanks for dental purposes in comparatively high numbers. This is efficient from the point of view of cost, in particular.

The object is further achieved by a compression apparatus having a reduced-pressure chamber, wherein a multiple mold of the invention is disposed in the reduced-pressure chamber of the compression apparatus. In this connection, the compression apparatus is a stationary compression apparatus in which the multiple mold can be used. As well as the reduced-pressure chamber, the compression apparatus may also comprise a heating device. In this case, the compression apparatus may also be referred to as an oven. Overall, it is thus possible, using the multiple mold in the compression apparatus, to simultaneously produce at least two glass-ceramic blanks. This is comparatively efficient, especially by comparison with a compression apparatus in which only a single mold, i.e. a mold by which only a single glass-ceramic blank can be produced, is used. In the present context, the compression apparatus may be incorporated into a plant for production of glass-ceramic blanks. In this connection, the compression apparatus may be disposed within a reduced-pressure chamber which ensures that the compressing takes place in a reduced-pressure atmosphere. Irrespective of whether further components of the system for production of glass-ceramic blanks are disposed in this reduced-pressure chamber, such a reduced-pressure chamber is regarded as a reduced-pressure chamber of the compression apparatus.

The compression apparatus may comprise a support plate having a support surface to directly or indirectly bear the multiple mold. It is thus possible to bear the multiple mold safely and reliably within the compression apparatus. This is particularly true of multiple molds that are designed without a support plate.

The compression apparatus may also comprise a pressure ram which is mounted movably such that, by means of the pressure ram, objects positioned in the receiving volume of the multiple mold can be subjected to a force. Such a pressure ram thus limits the receiving volume. It is consequently possible to produce geometrically defined glass-ceramic blanks. In addition, by means of the pressure ram, the powder blanks can be subjected to a controlled force, i.e. put under mechanical pressure. The compression apparatus is thus suitable for subjecting the powder blanks to a compression method.

For production of the glass-ceramic blanks by means of the compression apparatus, it is possible, for example, to heat the powder blanks first to a temperature of 700° C. or more. Once this temperature has been attained, a compression force can be applied to the powder blanks. The method can be conducted within the reduced-pressure chamber under reduced pressure, i.e. in a technical vacuum.

It is emphasized that a compression apparatus with a heating device does not make the heating device of the multiple mold obsolete. Instead, the two heating devices are complementary to one another in that the heating device of the multiple mold is used to heat the powder blanks, and the heating device of the compression apparatus heats the multiple mold overall and hence reduces or avoids thermal losses.

Moreover, the object is achieved by a continuous system for production of glass-ceramic blanks for dental purposes. The continuous system comprises a heating station, a compression station and a cooling station, wherein the heating station, the compression station and the cooling station are each designed to accommodate at least one mold, especially a multiple mold of the invention. In addition, the continuous system comprises a transport device for transferring the mold and/or at least one powder blank from the heating station into the compression station and from the compression station into the cooling station. The continuous system may be operated with a single mold, i.e. a mold designed to produce only a single glass-ceramic blank, or a multiple mold, in particular a multiple mold of the invention.

With regard to the fact that the transport device may be designed to transfer the mold and/or at least one blank, several alternatives are apparent. In a first alternative, by means of the transport device, the mold is transferred from the heating station into the compression station and from the compression station into the cooling station. The mold here contains one or more powder blanks or glass-ceramic blanks, such that these are transferred together with the mold. In a second alternative, at least one mold is fixedly assigned to the compression station. This means that the blank passes through the heating station without the mold and has to be inserted into the mold of the compression station. In the same way, the blank has to be demolded from the mold of the compression station after the hot pressing and pass through the cooling station without the mold. The first alternative can therefore also be referred to as a continuous system with a running or through-pass mold, the second alternative as a continuous system with a fixed mold.

It will be apparent that, in the second alternative, the powder blanks have to be demolded in the hot state. For this purpose, the mold has to be opened. Free shrinkage of the blank and subsequent removal is not possible. This implies that the blank can be handled at all stations in the second alternative.

Furthermore, in the second alternative, a cleaning step has to be provided. In this way, the molds are prepared again to accept a new powder blank and for conversion to a glass-ceramic blank by hot pressing. After at least the compression takes place under reduced pressure or vacuum, mechanical cleaning of the mold is preferred. This can also take place under vacuum conditions.

The continuous system can be operated by means of a method of producing glass-ceramic blanks, in which the powder blanks are first heated to a temperature of 700° C. or more, for example in the heating station, and only after attainment of that temperature are they subjected to a compression force, which can be effected within the compression station, for example. The temperature of 700° C. or more may thus also be used in this connection as trigger criterion for the application of a compression force.

Since the heating and cooling of the mold including the blanks present therein typically takes longer than the compression operation, the heating station and the cooling station are preferably designed to accommodate more molds with blanks than the compression station. In this way, the different processing times of the individual stations can be compensated so as to result in a fluid transfer of the molds and/or blanks through the continuous system. This is of course applicable to the variant with a running mold and the variant with a fixed mold.

The heating station may comprise at least two fixed temperature zones. Alternatively or additionally, the cooling station may comprise at least two fixed temperature zones. A mold with powder blanks present therein can thus be subjected to a defined temperature profile in that it passes through the at least two fixed temperature zones. As an alternative to this, it is of course also possible that the mold is subjected to a defined temperature profile at a single site. In both variants, the mold with the powder blank can be subjected to a defined temperature profile in the heating station and/or the cooling station.

### BRIEF DESCRIPTION OF THE DRAWINGS

The invention is described hereinafter with reference to various working examples that are shown in the appended drawings. The figures show:

FIG. 1 a continuous system of the invention according to a first working example, with a compression apparatus of the invention in which a multiple mold of the invention may be disposed,

FIG. 2 a continuous system of the invention according to a second working example, with a compression apparatus of the invention in which a multiple mold of the invention may be disposed,

FIG. 3 a multiple mold of the invention in a perspective view,

FIG. 4 the multiple mold of the invention from FIG. 3 in a section diagram along the plane IV in FIG. 3, additionally showing parts of an assigned compression apparatus of the invention for better understanding, and

FIG. 5 the multiple mold of the invention from FIGS. 3 and 4 in a partly filled state.

### DETAILED DESCRIPTION

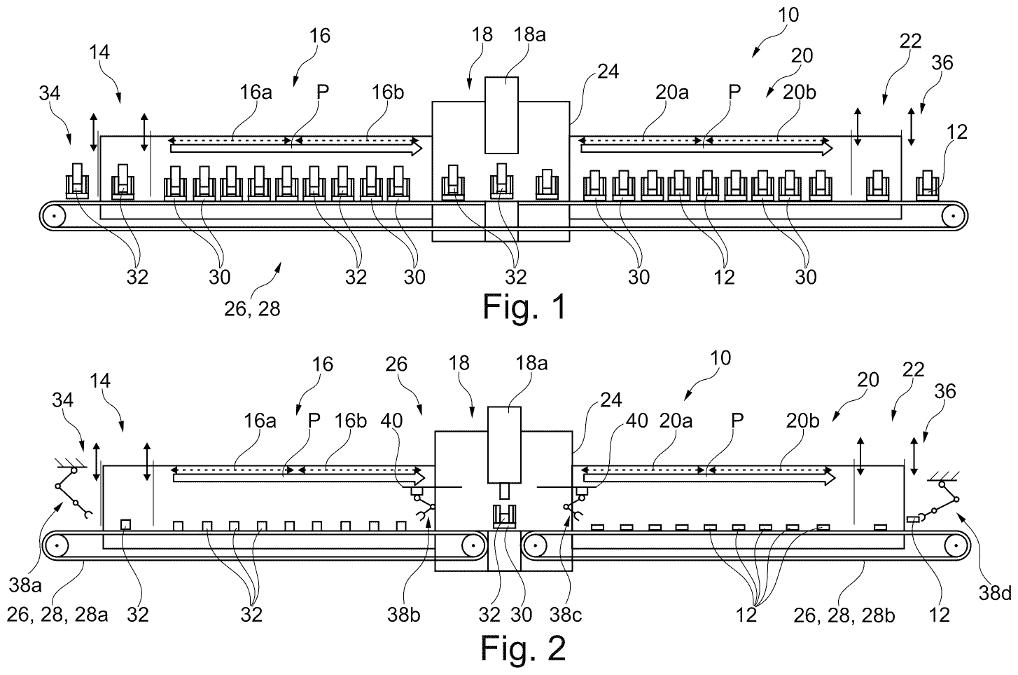

FIG. 1 shows a continuous system 10 for production of glass-ceramic blanks 12 for dental purposes. Such a glass-ceramic blank 12 can be used, for example, to create a dental restoration.

In particular, such a glass-ceramic blank 12 can be used to create crowns, abutments, abutment crowns, inlays, onlays, veneers, bridges and overdentures.

In a process direction P, the continuous system 10 comprises an inlet lock 14, a heating station 16, a compression station 18, a cooling station 20 and an outlet lock 22.

The heating station 16, the compression station 18 and the cooling station 20 are disposed within a reduced-pressure chamber 24.

Accordingly, the inlet lock 14 and the outlet lock 22 are designed as pressure locks or vacuum locks.

The continuous system 10 further comprises a transport device 26, which, in the embodiment shown, comprises a conveyor belt 28 shown in simplified form.

In the first working example according to FIG. 1, the transport device 26 is designed to transfer molds 30 through the continuous system 10, in each of which is at first positioned a powder blank 32 and later on, i.e. after a hot pressing operation, a glass-ceramic blank 12.

The molds 30 with the respective powder blanks 32 are transferred from an introduction region 34 which is upstream of the inlet lock 14 in process direction P, through the inlet lock 14 and into the heating station 16. Thereafter, the molds 30 with the respective powder blanks 32 are transferred from the heating station 16 into the compression station 18.

Within the compression station 18, the powder blanks 32 are each converted by hot pressing to a glass-ceramic blank 12.

Subsequently, the molds 30 with the respective glass-ceramic blanks 12 are transferred from the compression station 18 into the cooling station 20. Proceeding from the cooling station 20, the molds 30 with the respective glass-ceramic blanks 12 are transferred through the outlet lock 22 into an exit region 36. The molds with the glass-ceramic blanks 12 can be removed there from the continuous system 10.

For better clarity, in FIG. 1, only some of the molds 30, only some of the powder blanks 32 and only some of the glass-ceramic blanks 12 are given a reference numeral.

In order to assure a uniform progression of the molds 30 with the respective powder blanks 32 or the respective glass-ceramic blanks 12 through the continuous system 10, and simultaneously to take account of the fact that the molds 30 with the respective powder blanks 32 or glass-ceramic blanks 12 are processed for different periods of time in the different stations, the individual stations are designed to accommodate a different number of molds 30 with respectively assigned powder blanks 32 or glass-ceramic blanks 12.

In detail, in the embodiment shown, the introduction region 34 is designed to accommodate a single mold 30 with an accompanying powder blank 32.

The inlet lock 14 is also designed to accommodate a single mold 30 with an accompanying powder blank 32.

The heating station 16 is designed to accommodate a total of nine molds 30 each with an accompanying powder blank 32.

The heating station 16 has a first fixed temperature zone 16a and a second fixed temperature zone 16b. The temperature in the first fixed temperature zone 16a is lower than in the second fixed temperature zone 16b.

The molds 30 with the respectively accompanying powder blanks 32 are thus heated in two stages as they pass through the heating station 16.

The compression station 18 is designed to accommodate a total of three molds 30.

At any time, only one single mold 30 with accompanying powder blank 32 is disposed within the compression apparatus 18a. The powder blank 32 is converted therein to a glass-ceramic blank 12.

A mold 30 with accompanying powder blank 32 is present within the compression station 18, but upstream of the compression apparatus 18a in process direction P.

A further mold 30 with accompanying glass-ceramic blank 12 is within the compression station 18, but beyond the compression apparatus 18a in process direction P.

The cooling station 20 is again designed to accommodate a total of nine molds 30 with respectively accompanying glass-ceramic blanks 12.

Analogously to the heating station 16, the cooling station 20 also has a first fixed temperature zone 20a and a second fixed temperature zone 20b. A temperature in the second fixed temperature zone 20b is lower than in the first fixed temperature zone 20a.

FIG. 2 shows a continuous system 10 for production of glass-ceramic blanks 12 for dental purposes, which is designed according to a second working example. All that are elucidated hereinafter are the differences from the first working example from FIG. 1. Identical or mutually corresponding elements are given the same reference numerals.

In the working example according to FIG. 2, the difference from the working example according to FIG. 1 is that the mold 30 is fixedly positioned within the compression station 18. The mold 30 is thus also fixedly positioned within the continuous system 10.

Accordingly, the transport device 26 in the second working example is merely designed to transport powder blanks 32 and glass-ceramic blank 12, but not molds 30.

Therefore, in the second embodiment, the conveyor belt 28 is divided into two conveyor belt sections 28a, 28b, where conveyor belt section 28a is assigned to the introduction region 34, the inlet lock 14, the heating station 16, and partly to the compression station 18.

Conveyor belt section 28b is assigned to the cooling station 20, the outlet lock 22, the exit region 36, and likewise partly to the compression station 18.

In addition, the transport device 26 in the second working example comprises a total of four gripper units 38a, 38b, 38c, 38d.

Gripper unit 38a is positioned upstream of the inlet lock 14 in process direction P and within the introduction region 34.

Gripper unit 38d is positioned beyond the outlet lock 22 in process direction P and within the exit region 36.

The two gripper units 38b and 38c are positioned within the reduced-pressure chamber 24. Each of the two gripper units 38b and 38c is coupled to a linear movement unit 40. Gripper units 38b and 38c may thus be moved in process direction P by means of the respectively assigned linear movement unit 40 within the reduced-pressure chamber 24.

One of the linear movement units 40, coupled to gripper unit 38b, is positioned upstream of the compression apparatus 18a in process direction P, and the other of the linear movement units 40, coupled to gripper unit 38c, beyond the compression apparatus 18a in process direction P.

In the continuous system 10 according to FIG. 2, the powder blanks 32 thus pass through the process implemented by the continuous system 10.

In this process, a powder blank 32 is first placed by gripper unit 38a onto conveyor belt section 28a and then transported into the inlet lock 14 by means of conveyor belt section 28a.

The powder blank 32, as already elucidated in connection with the first working example from FIG. 1, is thence transported through the heating station 16 by means of the conveyor belt section.

As in the first working example, the heating station 16 comprises a first fixed temperature zone 16a and a second fixed temperature zone 16b. Within the heating station 16, the powder blank 32 is thus heated first in the first fixed temperature zone 16a and, after a certain time has elapsed, in the second fixed temperature zone 16b.

Subsequently, gripper unit 38b is used to insert the powder blank 32 into the mold 30 of the compression station 18, and in particular into the mold 30 of the compression apparatus 18a. The powder blank 32 is subjected to hot pressing therein.

Subsequently, the glass-ceramic blank 12 formed from the powder blank 32 by hot pressing is taken from the mold 30 of the compression apparatus 18 by means of gripper unit 38c and placed onto conveyor belt section 28b.

On conveyor belt section 28b, the glass-ceramic blank 12 passes through the cooling station 20, more specifically the first fixed temperature zone 20a of the cooling station 20 and the second fixed temperature zone 20b.

Once the glass-ceramic blank 12 has cooled sufficiently, it is transferred by means of the conveyor belt section through the outlet lock 32 into the exit region 36.

The glass-ceramic blank 12 is removed therefrom by means of gripper unit 38d.

It will be apparent that it must always be possible to handle the powder blank 32 in the second working example. The powder blank 32 is accordingly provided, for example, as a coherent white body or green body.

It will also be apparent that gripper units 38a, 38b, 38c, 38d are shown merely schematically. Depending on the application, it is also possible to provide more or fewer gripper units 38a, 38b, 38c, 38d.

The continuous system 10 has been elucidated above in connection with molds 30 that are each designed as single molds. Such molds are designed always to accommodate just a single powder blank 32 or a single glass-ceramic blank 12.

Rather than the molds 30, however, it is also possible to use a multiple mold 42 within the continuous system 10 according to the first working example (see FIG. 1). The above remarks are correspondingly applicable.

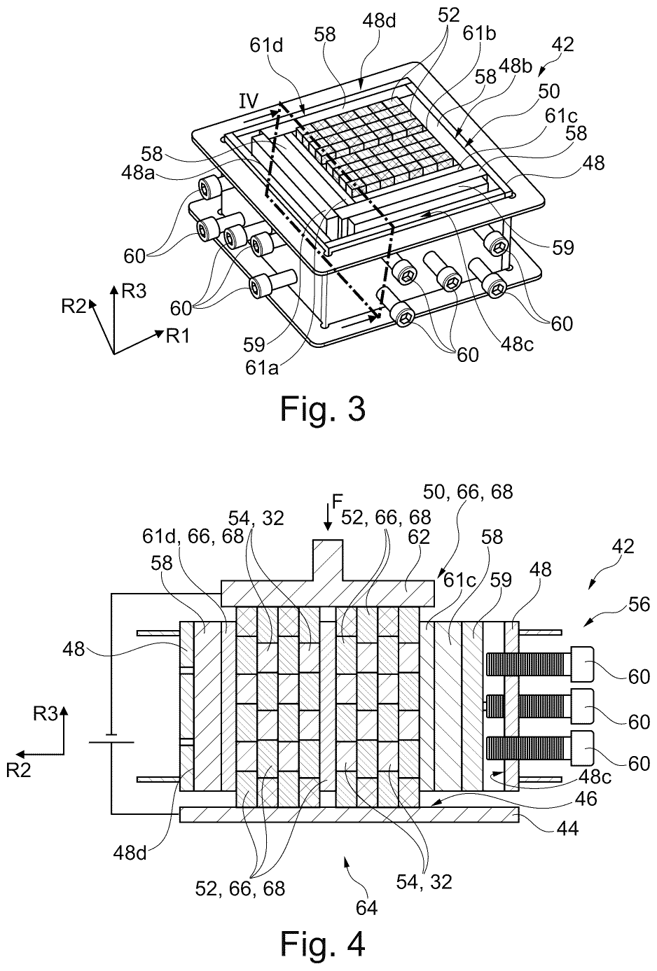

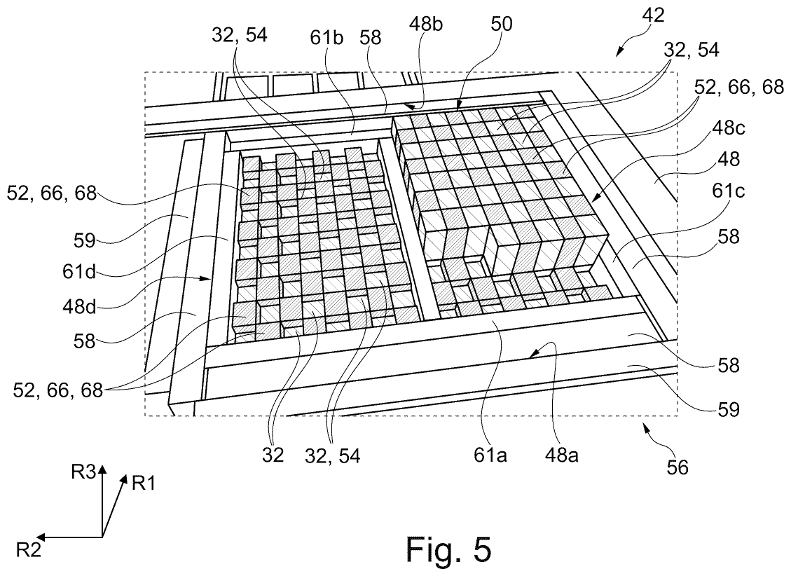

The multiple mold 42 and the use thereof for production of a glass-ceramic blank 12 for dental purposes are elucidated hereinafter in association with FIGS. 3 to 5.

A glass-ceramic blank 12 which is produced by means of the multiple mold 42 can be used, for example, to create a dental restoration.

The multiple mold 42 does not comprise a support plate in the examples from FIGS. 3 to 5.

For better understanding, however, in FIG. 4, a support plate 44 of an assigned compression apparatus 18a is shown, which has a support surface 46 to bear the multiple mold 42 and especially the powder blanks 32 present therein.

Likewise shown in FIG. 4 for better understanding is a pressure ram 62 of the compression apparatus 18a.

The multiple mold 42 comprises a frame 48 which, in the working example shown, has a square cross section.

The frame 48 here defines a receiving volume 50.

The multiple mold 42 further comprises, in the working example shown, a multitude of separating elements 52. All the separating elements 52 are disposed within the receiving volume 50 and are designed to divide the receiving volume 50 into multiple subvolumes 54. For this purpose, adjacent separating elements 52 each overlap in their edge regions (cf. FIG. 4).

Each of these subvolumes 54 is designed to accommodate a powder blank 32.

In the working example shown in FIGS. 3 and 4, each of the subvolumes 54 is filled with such a powder blank 32.

The receiving volume 50 is thus also a receiving volume 50 for the powder blanks 32.

In the working example shown, the subvolumes 54 and the separating elements 52 form a regular, three-dimensional pattern.

This means that, in three directions R1, R2, R3, corresponding to the three spatial dimensions, multiple separating elements 52 and subvolumes 54 or powder blanks 32 disposed therein are arranged alternately.

The first direction R1 extends from a first end face 48a of the frame 48 to a second end face 48b of the frame 48. The first end face and the second end face are opposite one another.

The second direction R2 is at right angles to the first direction R1 and hence extends from a third end face 48c of the frame 48 to a fourth end face 48 of the frame 48. The third end face 48c and the fourth end face 48d are opposite one another. In addition, the third end face 48c and the fourth end face 48d are each between the first end face 48a and the second end face 48b.

The third direction R3 is at right angles to the first direction R1 and the second direction R2.

A clamp apparatus 56 is additionally provided on the frame 48. This is designed to clamp the separating elements 52 and the powder blanks 32 within the receiving volume 50. In other words, the powder blanks 32 and the separating elements 52 are held within the frame 48 in a force-fitting manner by means of the clamp apparatus 56.

In the working example shown, the clamp apparatus 56 has a total of four clamping plates 58 between which, by actuation of a total of ten clamping screws 60, the powder blanks 32 and the separating elements 52 can be clamped in.

In order to be able to introduce the pressure applied by means of the clamping screws 60 with maximum uniformity into the clamping plates 58 and into the separating elements 52 and powder blanks 32, the respective ends of the clamping screws 60 act on the clamping plates 58 by means of two pressure plates 59.

For the same purpose, in addition, compensation plates 61a, 61b, 61c and 61d are provided on each side, adjoining the powder blanks 32 and separating elements 52.

During a hot pressing operation, the receiving volume 50 is restricted by means of the pressure ram 62 of the compression apparatus 18a and the support plate 44 of the compression apparatus 18a (cf. FIG. 4).

The pressure ram 62 is mounted here so as to be movable in such a way that, by means of the pressure ram 62, objects positioned in the receiving volume 50, i.e. in particular the separating elements 52 and the powder blanks 32, can be subjected to a compression force F in the direction of the receiving plate 44.

For this purpose, the overlap already mentioned between edge regions of adjacent separating elements 52 is configured such that adjacent separating elements 52 can slide against one another in the direction R3, such that the powder blanks 32 disposed in the subvolumes 54 can be compressed (see FIG. 4).

The separating elements 52 thus act as compression ram elements for the respectively adjoining subvolumes 54.

The multiple mold 42 also comprises a heating apparatus 64, which is shown only in FIG. 4 for better clarity.

The heating apparatus 64 is designed to heat the receiving volume 50 and hence the powder blanks 32 positioned therein.

The heating apparatus 64 in the working example shown is designed as an electrical resistance heater.

In this connection, it comprises a multitude of electrical resistance heating elements 66.

In the embodiment shown, some of the separating elements 52 form resistance heating elements 66. Only the cross-hatched separating elements 52 are designed as electrical insulators.

In addition, the compensation plates 61a, 61b, 61c, 61d of the clamp apparatus 56 form electrical resistance heating elements 66. The compensation plates 61a, 61b, 61c, 61d are thus electrically conductive.

In this connection, the separating elements 52 each comprise a graphite material. More specifically, in the present context, the electrically conductive separating elements 52 are manufactured from a graphite material.

Thus, each of the electrically conductive separating elements 52 forms a separate heating segment 68, by means of which the respectively adjoining powder blanks 32 can be heated.

It is thus possible to control a distribution of the heating output within the receiving volume 50.

In the example shown in FIG. 4, the circuit of the heating apparatus 64 is completed via the pressure ram 62 and the support plate 44 of the compression apparatus 18a, which is thus electrically conductive at least in sections.

By contrast, the clamping plates 58 are designed to be electrically nonconductive. They serve to electrically insulate the heating apparatus 64 from the clamping apparatus 56.

For better clarity, in FIG. 4, just some of the electrical resistance heating elements 66 and just some of the heating segments 68 are given a reference numeral. In an alternative embodiment, which is not shown in the figures, the heating apparatus 64 comprises at least one induction heating element. The heating apparatus 64 is thus designed as an induction heater.

It is noted that the heating apparatus 64 of the multiple mold 42 does not replace but rather complements a heating apparatus of the continuous system 10 in the heating station 16. Glass-ceramic blanks 12 are thus produced using both the heating apparatus 64 of the multiple mold 42 and a heating apparatus of the heating station 16.

### LIST OF REFERENCE NUMERALS

10 continuous system
12 glass-ceramic blank
14 inlet lock
16 heating station
16a first fixed temperature zone of the heating station
16b second fixed temperature zone of the heating station
18 compression station
18a compression apparatus
20 cooling station
20a first fixed temperature zone of the cooling station
20b second fixed temperature zone of the cooling station
22 outlet lock
24 reduced-pressure chamber
26 transport device
28 conveyor belt
28a conveyor belt section
28b conveyor belt section
30 mold
32 powder blank
34 introduction region
36 exit region
38a gripper unit
38b gripper unit
38c gripper unit
38d gripper unit
40 linear movement unit
42 multiple mold
44 support plate
46 support surface
48 frame
48a first end face
48b second end face
48c third end face
48d fourth end face
50 receiving volume
52 separating element
54 subvolume
56 clamp apparatus
58 clamping plate
59 pressure plate
60 clamping screw
61a compensation plate
61b compensation plate
61c compensation plate
61d compensation plate
62 pressure ram
64 heating apparatus
66 electrical resistance heating element
68 heating segment
F compression force
P process direction
R1 spatial dimension
R2 spatial dimension
R3 spatial dimension

1. A multiple mold (42) for production of at least two glass-ceramic blanks (12) for dental purposes from at least two powder blanks (32) by hot pressing, comprising
a frame (48) that defines at least sections of a receiving volume (50) for the at least two powder blanks (32), and
at least one separating element (52) which is disposed within the receiving volume (50) and divides the receiving volume (50) into at least two subvolumes (54), each of which is designed to accommodate one of the at least two powder blanks (32).

2. The multiple mold (42) as claimed in claim 1, comprising a support plate (44) with a support surface (46) to directly or indirectly bear the at least two powder blanks (32).

3. The multiple mold (42) as claimed in claim 1, further comprising a heating apparatus (64) for heating at least a section of the receiving volume (50).

4. The multiple mold (42) as claimed in claim 3, wherein the heating apparatus (64) comprises at least two separate heating segments (68) for independent heating of two different sections of the receiving volume (50).

5. The multiple mold (42) as claimed in claim 3, wherein the heating apparatus (64) comprises at least one induction heating element.

6. The multiple mold (42) as claimed in claim 3, wherein the heating apparatus (64) comprises at least one electrical resistance heating element (66).

7. The multiple mold (42) as claimed in claim 6, wherein the separating element (52) is formed at least in sections as a resistance heating element (66).

8. The multiple mold (42) as claimed in claim 6, wherein the multiple mold (42) comprises at least two resistance heating elements (66) and the at least two resistance heating elements (66) have different electrical resistances.

9. The multiple mold (42) as claimed in claim 1, wherein the separating element (52) comprises a graphite material or has been produced from a graphite material.

10. The multiple mold (42) as claimed in claim 1, wherein a clamp apparatus (56) for clamping the separating element (52) and the at least two powder blanks (32) within the receiving volume (50) is provided on the frame (48).

11. The multiple mold (42) as claimed in claim 10, wherein the clamp apparatus (56) is formed at least in sections as a resistance heating element (66).

12. The multiple mold (42) as claimed in claim 1, wherein a compensation plate (61a, 61b, 61c, 61d) is provided within the receiving volume (50) and adjoining at least one of the powder blanks (32) and/or adjoining the separating element (52).

13. The multiple mold (42) as claimed in claim 12, wherein the compensation plate (61a, 61b, 61c, 61d) is formed at least in sections as a resistance heating element (66).

14. The multiple mold (42) as claimed in claim 1, wherein two or more separating elements (52) and subvolumes (54) are arranged alternately in a first direction (R1) that extends from a first end face (48a) of the frame (48) to a second end face (48b) of the frame (48), wherein the first end face (48a) and the second end face (48b) are opposite one another.

15. The multiple mold (42) as claimed in claim 14, wherein two or more separating elements (52) and subvolumes (54) are arranged alternately in a second direction (R2) at right angles to the first direction (R1).

16. The multiple mold (42) as claimed in claim 15, wherein two or more separating elements (52) and subvolumes (54) are arranged alternately in a third direction (R3) that runs at right angles to the first direction (R1) and at right angles to the second direction (R2).

17. A method of using the multiple mold (42) as claimed in claim 1 for production of a glass-ceramic blank (12) for dental purposes.

18. A compression apparatus (18a) having a reduced-pressure chamber (24), wherein the multiple mold (42) as claimed in claim 1 is disposed in the reduced-pressure chamber (24) of the compression apparatus (18a).

19. A continuous system (10) for production of glass-ceramic blanks (12) for dental purposes, comprising
a heating station (16),
a compression station (18) and
a cooling station (20), wherein the heating station (16), the compression station (18) and the cooling station (20) are each designed to accommodate at least one mold (30) or a multiple mold (42) as claimed in claim 1, and
a transport device (26) for transferring the mold (30) and/or at least one powder blank (32) from the heating station (16) into the compression station (18) and from the compression station (18) into the cooling station (20).

20. The continuous system (10) as claimed in claim 19, wherein the heating station (16) comprises at least two fixed temperature zones (16a, 16b) and/or wherein the cooling station (20) comprises at least two fixed temperature zones (20a, 20b).
